(19) United States
(12) Patent Application Publication
(10) Pub. No.: US 2006/0243086 A1
(43) Pub. Date: Nov. 2, 2006

(54) Power transmission and actuation of a legged robot

(76) Inventors: Mark R. Cutkosky, Palo Alto, CA (US); Sangbae Kim, Stanford, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/375,694

(22) Filed: Mar. 14, 2006

Related U.S. Application Data
(60) Provisional application No. 60/663,047, filed on Mar. 16, 2005.

(51) Int. Cl. B25J 18/00

(52) U.S. Cl. 74/490.02

(57) ABSTRACT

A power transmission system that permits efficient transmission of power to the legs of a legged robot is provided. Light and flexible push-pull cables in low-friction sleeves transmit power from a power generation source to the feet of the robot. The push-pull cables allow the legs to swing back and forth rapidly, with low inertia. Tuned axial compliance is inserted into the cable sheaths to optimize the end point displacement for maximum running speed. The design of the legs allows actuation via thrusting along the length of the leg. Soft flexures at the hips provide tuned, passive rotational stiffness and damping. The leg swing is passive and functions as a tuned oscillation system in combination with the thrusting cables. The new system preserves a fast, self-stabilizing behavior of the robots making it generally applicable to legged robots with two or more legs and of various sizes.

### CROSS-REFERENCE TO RELATED APPLICATIONS

This application is cross-referenced to and claims the benefit from U.S. Provisional Patent Application 60/663,047 filed Mar. 16, 2005, which is hereby incorporated by reference.

### STATEMENT REGARDING FEDERALLY SPONSORED RESEARCH OR DEVELOPMENT

The present invention was supported in part by grant number N00014-98-1-066 from the Office of Naval Research, Department of the Navy. The U.S. Government has certain rights in the invention.

### FIELD OF THE INVENTION

The invention relates generally to legged robotics. More particularly, the invention relates to power transmission and actuation mechanisms for legged robots.

### BACKGROUND

Developing a fast moving and autonomous legged robot is a non-trivial challenge. One of the difficulties relates to the transmission of power and actuation of the legs. In recent years a number of fast, legged robots have been developed that draw their inspiration from running arthropods or insects. When insects are moving rapidly they typically employ an alternating tripod gait and rely heavily on passive mechanical properties to achieve dynamic stability. The sprawled posture with large forces in the horizontal plane, and the compliance and damping in the limbs and joints, serve as “preflexes” that promote stable running and rapid recovery from perturbations (see e.g. T. M. Kubow and R. J. Full. The role of the mechanical system in control: a hypothesis of self-stabilization in hexapedal runners. Philosophical Transactions of the Royal Society of London Series B-Biological Sciences, 354(1385): 849-861, 1999; K. Meijer and R. J. Full. Stabilizing properties of invertebrate skeletal muscle. American Zoologist, 39, 1999).

In the case of the Sprawl family of robots developed by Mark R. Cutkosky et al. at Stanford University, the main principles adapted from insects, the cockroach in particular, are:
a sprawled posture, with a wide stance and rear legs directed backward;
a bouncing, alternating tripod gait based on an open-loop motor pattern;
specialization in which the rear legs primarily accelerate the robot while the front legs decelerate it;
a single active degree of freedom per leg, in which thrusting is directed along the axis of the leg;
passive “hip” joints that swing the legs forward between steps; and
compliance and damping that absorb perturbations.

The Sprawl robots are fabricated using a multi-material rapid prototyping process, Shape Deposition Manufacturing that makes it possible to achieve local variations in structural compliance and damping and to embed components such as sensors and actuators for increased ruggedness. Like their exemplars, the Sprawl robots are capable of fast locomotion over belly-height obstacles and of executing rapid turns by changing leg thrust angles (See Cham, J. G., Bailey, S. A., Clark, J. E., Full, R. J. and Cutkosky, M. R. Fast and Robust: Hexapedal Robots via Shape Deposition Manufacturing. The International Journal of Robotics Research. Volume 21 Issue 10, 1 Oct. 2002).

The robots can run without any proprioceptive or exteroceptive feedback; however, the addition of ground contact sensors allows the stride period to adapt automatically to changes in terrain or slope (See Cham, J. G., Karpick, J. K. and Cutkosky, M. R. Stride Period Adaptation for a Biomimetic Running Hexapod. International Journal of Robotics Research. February 2004, vol. 23, no. 2, pp. 141-153(13)).

A closer look at the dynamics of the running robots reveals motions and ground reaction forces similar to those found in insects and other small animals. This locomotion pattern has been termed SLIP (spring loaded inverted pendulum) in the literature and is seen in many running animals (See R. J. Full and D. E. Koditschek. Templates and anchors: Neuromechanical hypotheses of legged locomotion on land. Journal of Experimental Biology, 202(23): 3325-3332, 1999).

A limiting factor in the design of the previous Sprawl robots has been their use of pneumatic pistons for propulsion. Although electric motors are ubiquitous in small robots, pistons were chosen for the Sprawl robots as powerful, compact linear actuators. The main disadvantage to pneumatic pistons is that they virtually preclude autonomous operation. The volume of compressed gas needed for 10 minutes of operation is such that a gas storage tank would be too heavy to carry on board. Another limiting factor of present solutions in general is the relatively high inertia of the legs making it difficult to achieve high frequency while still achieving useful stride lengths. Accordingly, there is a need to develop new propulsion and actuation mechanisms to overcome the current shortcomings in the art.

### SUMMARY OF THE INVENTION

The present invention provides a new mechanism that permits efficient transmission of power to the legs of a legged robot (e.g. a hexapedal robot or one with a smaller or larger number of legs). This mechanism includes a power generation source adapted to generate push-pull motions, e.g. any type of rotational motor or any high-speed rotational motor or engine could be used and adapted if needed. In one example, an electrical motor is connected to a rotating double slider-crank mechanism that: (i) stores kinetic energy, and (ii) converts rotational motion to push-pull motion to actuate the legs of the robot.

Light and flexible push-pull cables in low-friction sleeves are used and capable to transmit power from the power generation source to the feet of the robot. The push-pull cables allow the legs to swing back and forth rapidly, with low inertia. Tuned axial compliance is inserted into the cable sheaths to optimize the end point displacement for maximum running speed.

The design of the legs allows actuation via thrusting along the length of the leg. Soft flexures at the hips provide tuned, passive rotational stiffness and damping. The leg swing is passive and functions as a tuned oscillation system in combination with the thrusting cables.

### BRIEF DESCRIPTION OF THE FIGURES

The objectives and advantages of the present invention will be understood by reading the following detailed description in conjunction with the drawing, in which:

FIG. 1 shows an example of a legged robot 100 which is a fully autonomous hexapedal robot driven by a rotational motor or engine 110 adapted to generate push-pull motions and flexible push-pull cables 120 connected to the legs 130 (4 visible of the 6) according to the present invention. In this example there are 6 flexible push-pull cables 130.

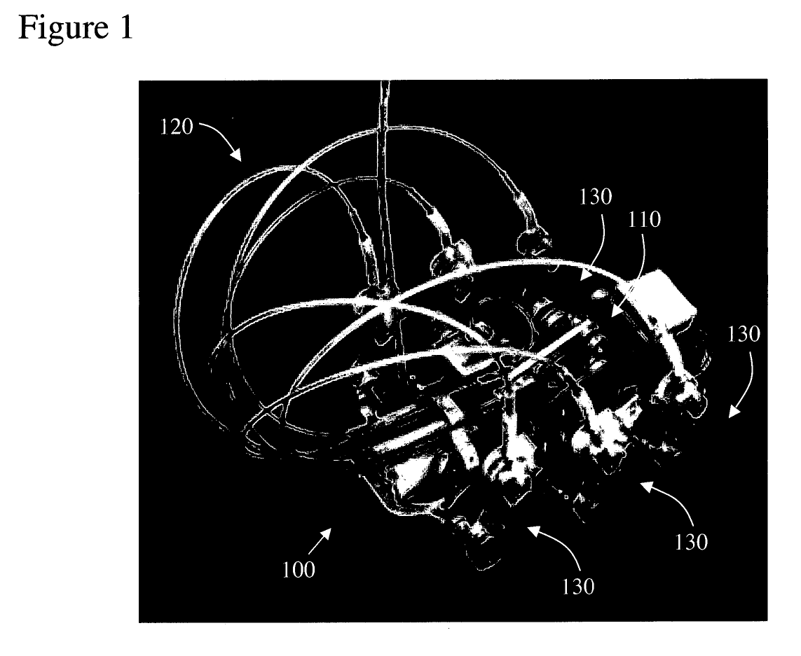

FIG. 2 shows an example of a power transmission system for a legged robot according to the present invention (top is an overview picture and bottom is a schematic side view). In this example a double crank-slider mechanism 210 is used to store and convert the rotational energy from the motor 220 to linear oscillations of the flexible push-push cables 230.

FIG. 3 shows an example of the power transmission system for a legged robot according to the present invention. The schematic sketch show flexible push-pull cables 310. Bottom view 320 in FIG. 3 is close up of boxed section 312 (note that box 132 itself is not part of push-pull cable 310). Push-pull cable 310 distinguishes a flexible cable 330 inside a flexible tube 340. Each end of the flexible tube has a rigid element 350 or a rigid shell. The flexible cable 330 could have rigid shafts 360 at each end as well to (i) at one end mechanically couple to the motor/engine or a double crank slider mechanism, and/or (ii) at the other end serve as a rigid leg. Arrows indicate movement direction of the push-pull motions.

FIG. 4 shows an example of a leg area 410 of a legged robot according to the present invention. Schematic 420 is a close up of the flexible push-pull cable near the leg. More specifically, this figure shows an example of the leg compression spring design 430 utilizing a tension spring 432 on the flexible tubing 340 around push-pull cable 330. Also shown are the frictional dampers on the front and middle legs.

FIG. 5 shows a schematic of the desired leg extension profile needed to produce a sinusoidal trajectory of the center of mass during stance. Dotted line shows trajectory that would occur without compression.

FIG. 6 shows theoretical and experimental leg extension profiles for iSprawl. Also shown are the path of the Center of Mass (COM) and the extension of the axial spring for each case. Curves for the measured leg extension and COM trajectory represent averages of three successive strides.

FIG. 7 shows an example of running speed of iSprawl vs. stride frequency.

FIG. 8 shows electrical power consumption of iSprawl without load and with running load.

FIG. 9 shows specific resistance vs. speed for iSprawl running on smooth terrain.

FIG. 10 shows the vertical and horizontal individual leg ground reaction forces for cockroach and Sprawlita (See S. A. Bailey, J. G. Cham, M. R. Cutkosky, and R. J. Full. Comparing the locomotion dynamics of the cockroach and a shape deposition manufactured biomimetic hexapod. In Experimental Robotics Vii, volume 271, pages 239-248, 2001) and for iSprawl, in comparison to the idealized slip model (See R. J. Full and D. E. Koditschek. Templates and anchors: Neuromechanical hypotheses of legged locomotion on land. Journal of Experimental Biology, 202(23):3325-3332, 1999).

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

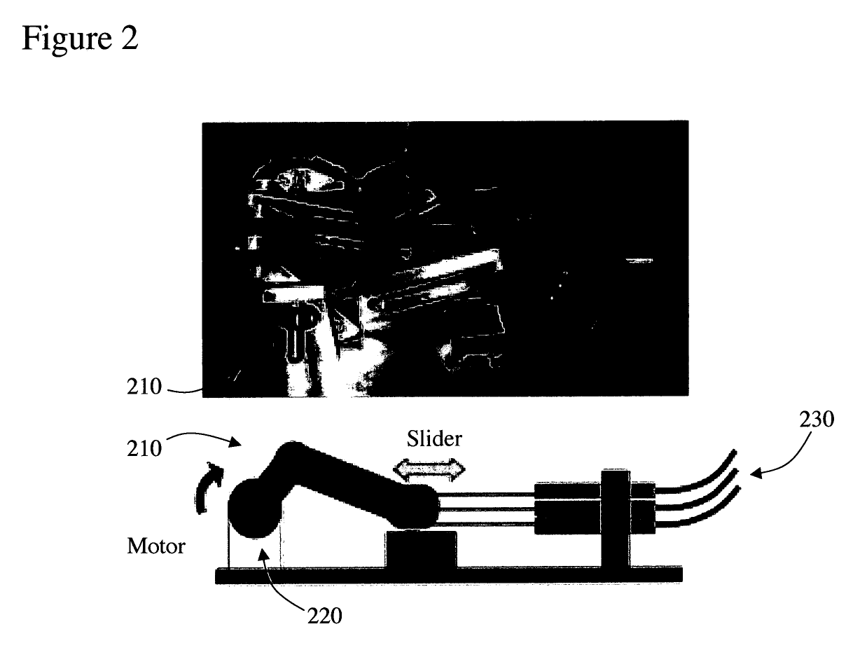

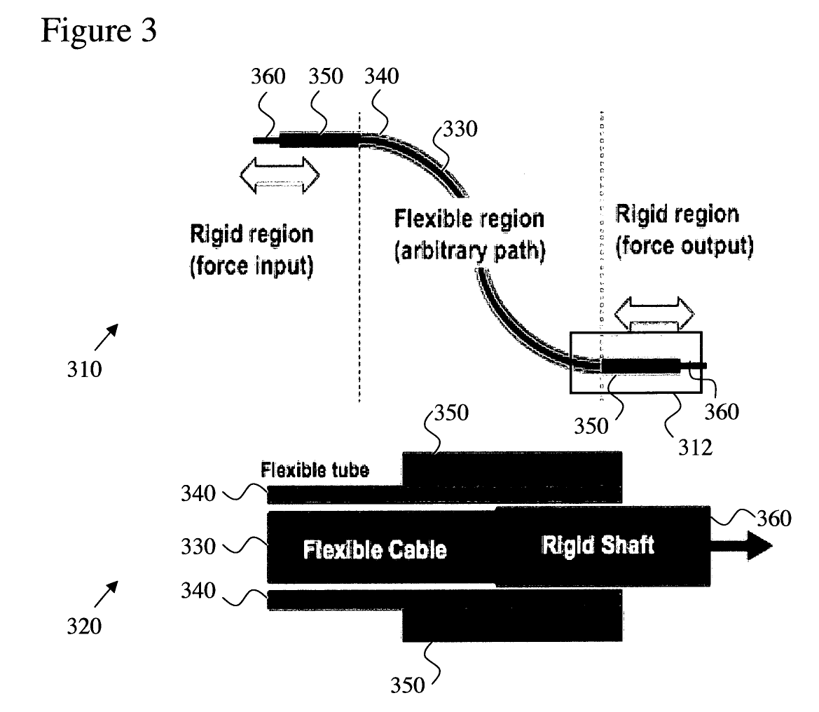

The most challenging aspects of utilizing electrical actuation for legged robots in general and the Sprawl robots in the specific embodiment of this invention are converting continuous rotation to periodic thrusting and incorporating sufficient flexibility into the power train to accommodate the repositioning of the legs. Several schemes were investigated before settling on the system presented in this invention. One major concern is power density, for which it is desirable to use a single high-speed rotational motor or engine as the primary actuation source. For large robots, the actuator energy can be stored elastically and periodically released as has been shown before. At the scale of robots like iSprawl however, it becomes easier to store kinetic energy. This is the approach shown in FIG. 2, in which a rotating double crank-slider mechanism stores rotational kinetic energy and converts it to alternating push-pull motions for each tripod of legs. The push-pull actions must also be distributed to the tips of the flexible, swinging legs. One possible solution is to employ liquid using a master/slave piston arrangement and flexible tubes. An early variant named “Aquasprawr” employed this method and achieved speeds of 3 body lengths per second. A lighter and more efficient alternative, as disclosed herein, is to use flexible cables in low-friction sleeves, as shown in FIG. 3. By adding rigid elements to both ends of the shaft and tube, the cables are able to thrust as well as pull. The end result is that the legs of iSprawl have a very low rotational inertia and a passive swing frequency of 45 Hz.

As in previous versions of Sprawl robots, the motions of the legs back and forth with each step are achieved passively by operating the robot as a resonant system. During each stance phase, the hip springs (i.e. rotational flexures) are loaded by the motion of the body. During the swing phase this stored energy is used to reposition the legs to their nominal orientation. In addition, remote control servos are mounted at the hips of the middle legs to change the equilibrium leg angles to effect turns. The physical specifications for an exemplary embodiment of iSprawl are given in Table I.

TABLE I
Physical Parameter for iSprawl

| | |
|---|---|
| Body size | 155 × 116 × 70 mm (excluding cables) |
| Body mass | 0.3 kg (including batteries and servo circuit) |
| Maximum speed | 2.3 m/s (15bodylength/s) |
| Stride frequency | 14 Hz |
| Power consumption | 12 W |
| Motor | Maxon2023909; size: 20 × 17.5 × 8 mm |
| Gear ratio | 20:1 |
| Legs | Polyurethane 72DC and 90A from Innovative |
| | Polymers |
| Servomotors | Cirrus cs-5.4 g |
| Typical leg motion | 25 mm stroke, 25 degrees swing |
| Battery | 6 pack of lithium polymer |
| | (3.7 V, 250 mAh per pack) |

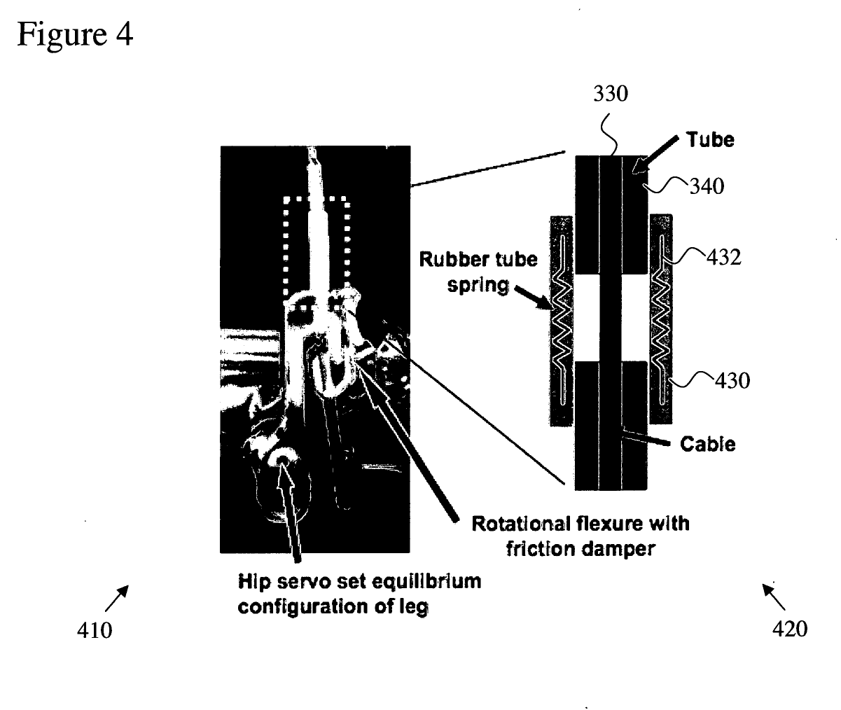

In one embodiment, iSprawl achieved speeds of approximately 5 body lengths per second. Review of high-speed video of its motion on a treadmill revealed numerous sources of inefficiency, including excessive and irregular pitch and roll oscillations and bouncing and slippage of the feet. These effects were gradually reduced by adjusting the center of mass location and the equilibrium angles of the front, middle and rear legs following a procedure similar to that of Clark (2004) (See J. E. Clark. Design, Simulation, and Stability of a Hexapedal Running Robot. PhD thesis, Stanford University, 2004). At this point, it became clear that foot contact forces were increasing too rapidly after initial contact, causing abrupt changes to the momentum of the robot and reducing efficiency. The effect is not surprising given that we have replaced a compliant force actuator (pneumatics) with a fixed displacement actuation from the slider-crank mechanism. To achieve a smoother, more SLIP-like motion, it was necessary to add tuned axial compliance to the push-pull cables, as shown in FIG. 4.

A. Desired Leg Extension Profile

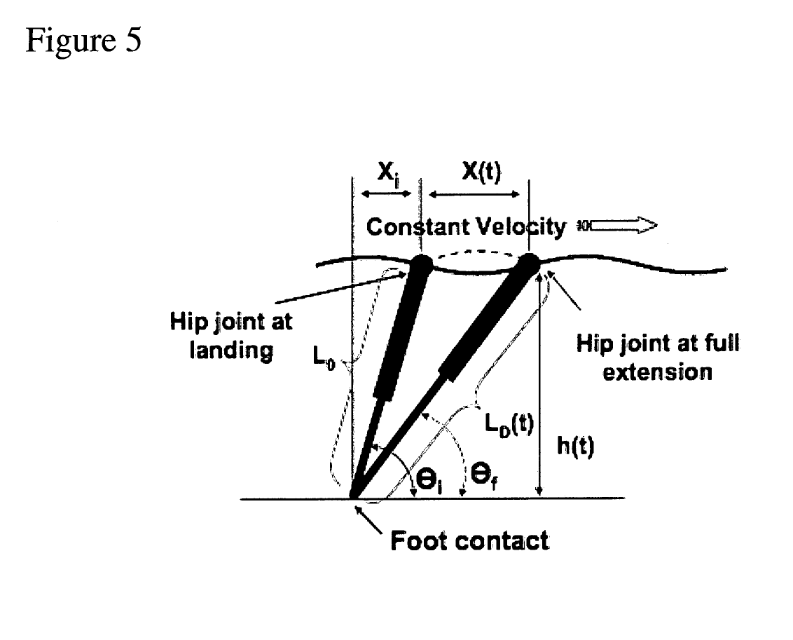

The hypothesis used in tuning the axial leg compliances is that the ideal motion of the robot is a smooth low-amplitude oscillation in the vertical plane and a nearly constant forward velocity, as indicated in FIG. 5. The constants used in these calculations are listed in Table II.

TABLE II
Parameters for model

| | |
|---|---|
| θi 7° | Leg initial angle |
| θf 45° | Legfinal angle |
| f 14 Hz | Leg oscillation frequency |
| v 2.3 m/s | Body forward velocity |
| hₙₒₘ 35 mm | Nominal body height |
| Δh 1 mm | Change in body height |

We begin by assuming that the height, h, of the body follows a sinusoidal path:
h(t)=hₙₒₘ+Δh sin(2π2ft) (1)
where hₙₒₘ is the nominal body height, Δhis amplitude of oscillation, and 2 f is the body oscillation frequency—the body's vertical oscillation frequency is twice the leg actuation frequency. The inital leg length, L₀, is given by:
L₀=hₙₒₘ/sin(θᵢ) (2)

Where θᵢ is the leg angle at touchdown. The horizontal position of the body at touchdown is given by:
Xᵢ=L₀ cos(θᵢ) (3)
and the forward position as a function of time is given by:
X(t)=vt (4)
which assumes a constant horizontal velocity, v. This is a reasonable assumption as the actual forward speed varies by less than 3 percent over a stride.

For the leg to remain in contact, the desired leg length, L_{D}(t), is given by:
L_{D}(t)=√(h(t)²+(xᵢ+x(t))²) (5)

For iSprawl the nominal leg extension trajectory, Lₙₒₘ(t), which is a function of the crank-slider mechanism, can be approximated as:
Lₙₒₘ(t)=A₀ sin(2πft)+L₀ (6)
where A₀=2.5 mm. The leg compression, Lₛ, is given by the difference between these and is:
Lₛ(t)=L₀+Lₙₒₘ(t)−L_{D}(t) (7)

The solution of these equations yields the maximum leg spring compression during stance
ΔL=max(Lₛ(t))=4 mm.

The body oscillates vertically at a frequency of 2 f=28 Hz, leading to a peak vertical acceleration of:
\ddot{h}ₘₐₓ=Δh(2π2f)2 (8)
and a maximum vertical ground reaction force of:
F_{h,max}=mg+mΔh(4πf)² (9)

With a body mass, m, of 0.31 kg the maximum predicted force, F_{H,MAX}, is 12.2N, which correlates well with the peak measured ground reaction forces found and discussed herein. The peak force occurs at a leg angle, θ, of approximately 55° or about half way through stance. Although the leg is not a free pin joint due to torsional hip compliance, we assume that the force is acting primarily along the axis of the leg. Thus the effective whole body leg spring constant should be:
k=(12.2N/sin(55°)/4 mm)=3.7 N/mm (10)

The front legs have the largest contribution (roughly 50%) to the vertical stiffness of the tripod. Accordingly, springs with a stiffness of 1.7N/mm inserted into the legs were found to give best performance. Note that to achieve the effect of a compression spring in series with the push-pull cables, it was actually easier to insert a corresponding tension element (a short section of latex rubber tubing) into the otherwise inextensible sheaths.

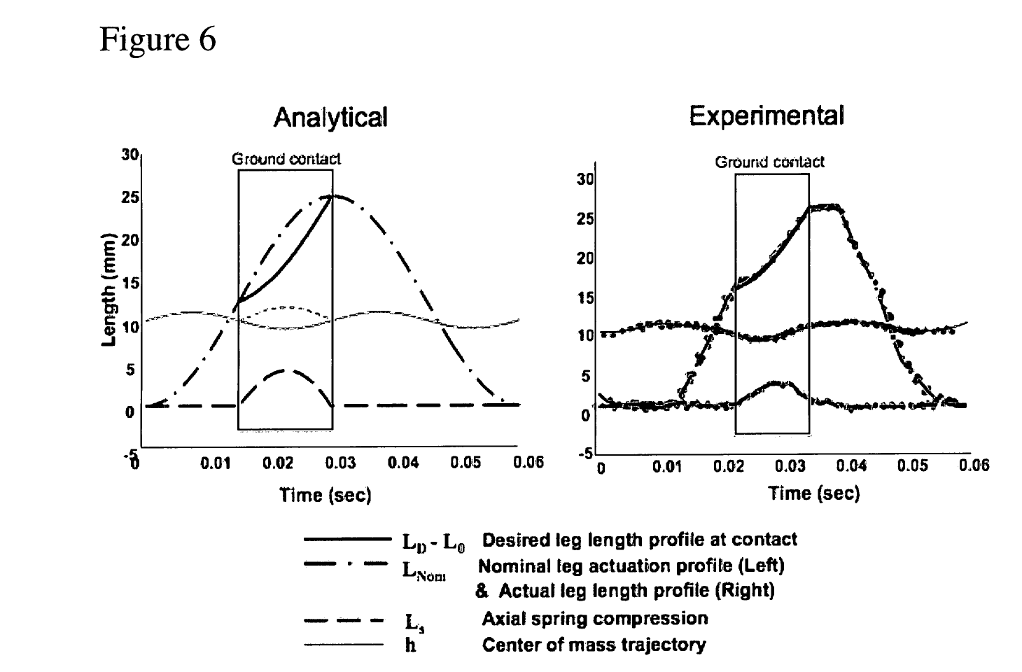

FIG. 6 shows the theoretical and the measured leg and body trajectories for a single stride. The trajectories for the measured case were obtained by filming iSprawl at 500 frames/second as it ran on a treadmill. The estimated positional accuracy is ±0.1 mm. The dark lines represent the desired leg extension profile during contact, and the thin lines represent the trajectory of the center of mass. The dotted segment in the analytical plot indicates the center of mass trajectory that would occur without the leg spring, whose compression is indicated by the dashed line at the bottom of the plot. The experimental data show that both the leg extension and center of mass trajectories match the model predictions closely. The experimentally measured axial spring compression is slightly smaller than the predicted value. This is compensated for by the inherent elasticity of the push-pull cable system. Adding axial compliance to the legs increased the robot's speed by 50%. It also reduced mechanical failures and produced a smoother periodic gait. In addition to tuning the axial compliance of the leg extension system, it was necessary to adjust the rotational compliance and damping of the passive hips. As with the earlier iSprawl robots, the legs are multi-material structures of hard and soft urethane. If the urethane flexures are too stiff, the legs do not flex enough and the stride length is reduced; if they are too soft the robot stumbles and loses open-loop stability (See J. E. Clark. Design, Simulation, and Stability of a Hexapedal Running Robot. PhD thesis, Stanford University, 2004). Empirically, rotational stiffnesses of approximately 72Nmm for the front legs, 54Nmm for the middle, and 36Nmm for the rear legs were found to give best results. In earlier Sprawl robots, the inherent visco-elasticity of the soft urethane provided adequate damping; for iSprawl it was necessary to add small friction dampers to the front and middle legs, as can be seen in FIG. 4.

B. Speed and Frequency

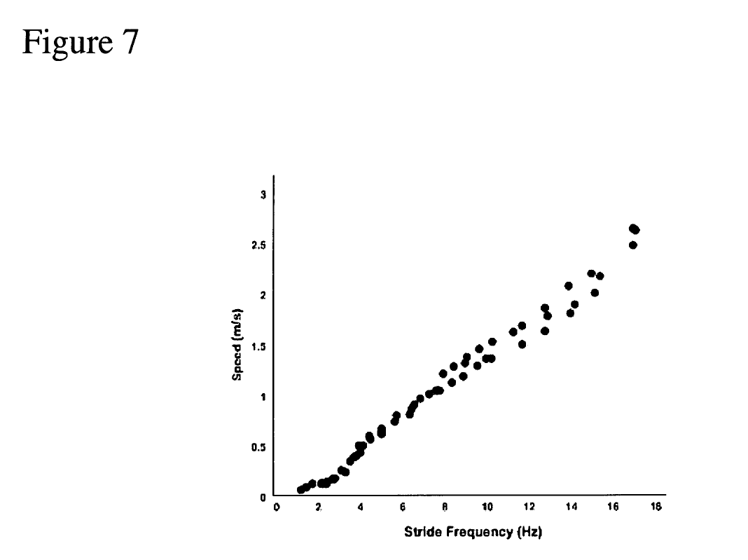

FIG. 7 shows the relationship between the robot's forward velocity and its stride period. The normal operation point for the robot is at 14-15 Hz, which corresponds to a speed of about 2.3 m/s. The relationship between forward speed and actuation frequency is nearly linear above 4 Hz, with no perceptible change in the motion pattern. Another value that has been used to measure locomotion speed in a scale independent manner is the Froude number, F, a dimensionless value that relates the inertial force to gravitational force or alternatively the translational kinetic energy to the gravitational potential energy of the system:
F=v²/gl
where v is the velocity of locomotion, g is the gravitational constant, and l is a characteristic leg length, often taken in running robots as the distance from the hip to the ground. Alexander and Jays have shown that a wide variety of animals transition from a walk to a trot and a trot to a gallop at similar Froude numbers (See Alexander R. McN. and A. S. Jayes. A dynamic similarity hypothesis for the gaits of quadrupdeal mammals. Journal of Zoology, pages 135-152, 1983). iSprawl exhibits a gait transition from walking to running (as defined by the phasing of its kinetic and gravitational potential energy) at about 3.5 Hz (F=0.4), which is close to the 0.5 value preferred by most animals). When running at its nominal frequency of 14 Hz iSprawl's Froude number is about 3.5. Generally speaking, the Froude number could be at least 3 for legged robots of various sizes and number of legs when the principles of the present invention are applied. Generally speaking, the push-pull cables could operate at a frequency of at least 10-15 Hz.
C. Energetics

Since the power supply contributes a relatively significant portion of total mass, energy efficiency is of crucial importance for autonomous legged robots. With the switch from a pneumatic to an electromechanical actuation scheme, precise measurement of the total power consumption is straightforward.

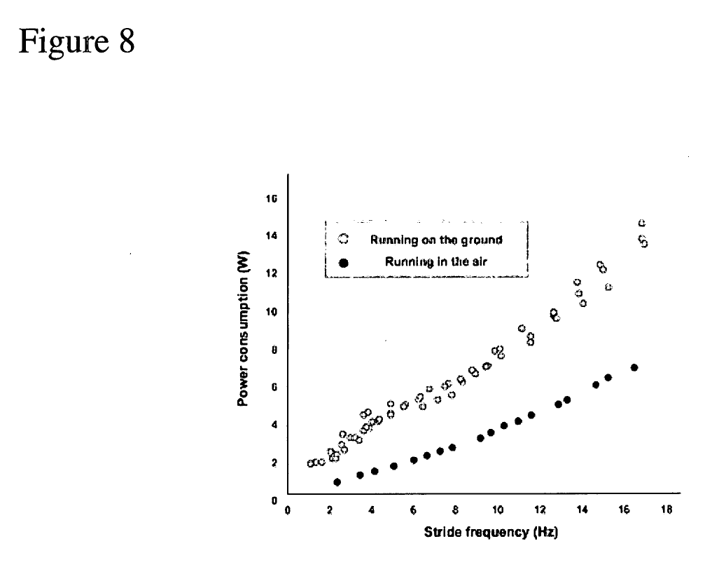

FIG. 8 shows the total power consumption while running on a treadmill and the non-productive power consumption (i.e., while running in air) as a function of stride frequency. The latter figure should be taken as a lower bound because the transmission forces, and the corresponding friction forces, are higher when the robot is in contact with the ground. When driven at low frequencies iSprawl's power consumption has a larger relative variation since the required motor torque fluctuates throughout stride. Beyond 5 Hz, the robot runs with a stable gait and a constant power consumption which is linearly proportional to stride frequency.

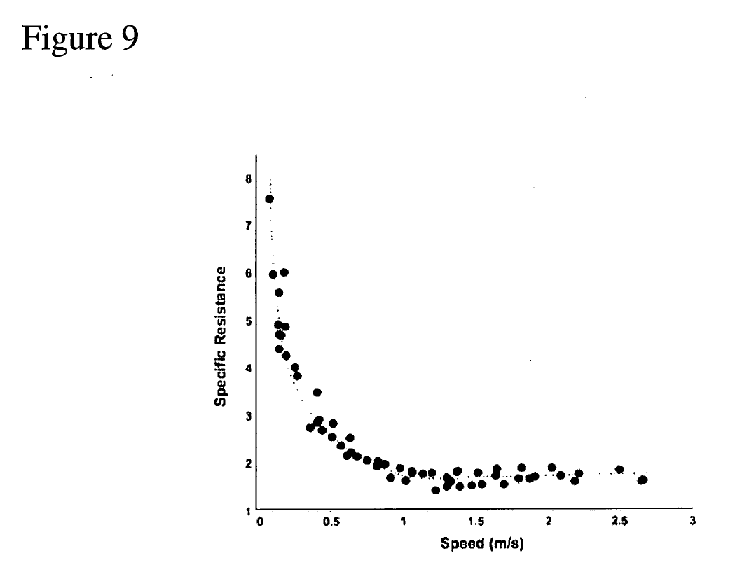

For comparison with other legged robots, FIG. 9 shows the specific resistance, P(v)/mgv, as a function of speed, where m is the mass of the robot, v is the forward velocity and P(v) is the total electrical power consumption. For the preferred running speeds of iSprawl, corresponding to stride frequencies above 7 Hz and speeds above 1 m/s, the specific resistance is nearly constant at 1.75. This value is comparable to that of other running robots, although higher than the most efficient of them. Looking again at FIG. 8, we observe that half the total power is consumed in the motor and transmission system, which suggests that specific resistance could be improved with a more efficient motor and gearbox and with an effort to reduce the sliding friction in the cables.

D. Ground Reaction Forces

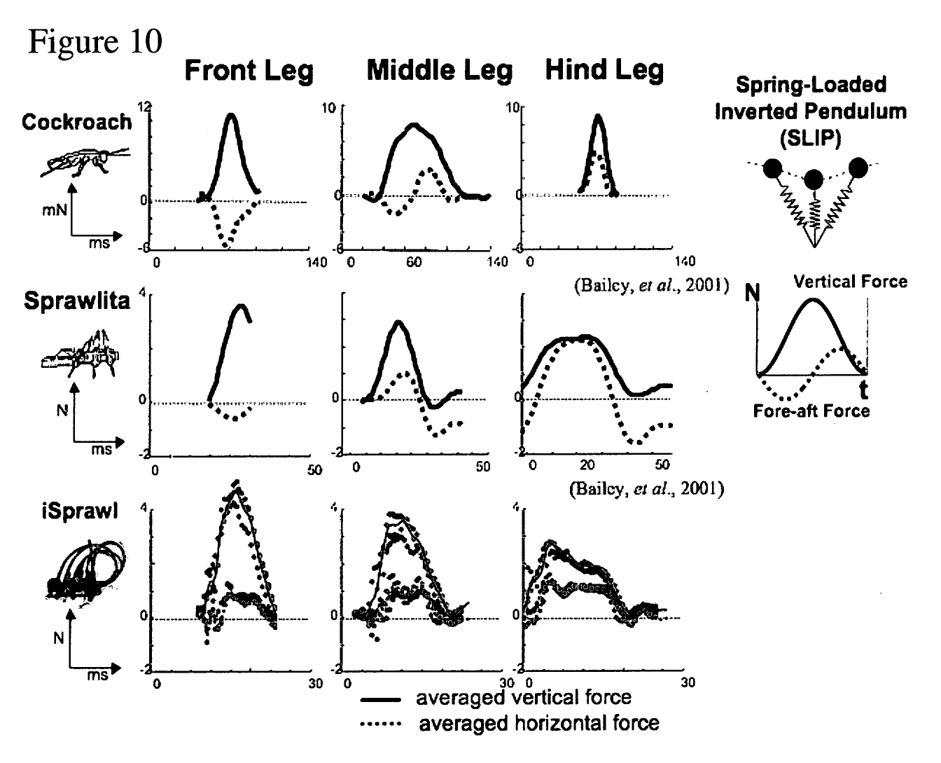

A final subject of comparison among iSprawl, the earlier Sprawl robots, and insects is the pattern of ground reaction forces (GRF). The pattern seen in insects is that the front legs provide a braking force at the start of each step while the rear legs provide most of the forward propulsion at the end of each step (taking touchdown as the beginning of the step). The middle legs provide a mixture of propulsion and braking (See R. J. Full, R. Blickhan, and L. H. Ting. Leg design in hexapedal runners. Journal of Experimental Biology, 158(UL):369-390, 1991). In addition, the front legs, being most nearly upright, have the largest vertical and smallest horizontal forces. The top two rows of FIG. 10 show the averaged GRFs for a cockroach running and for Sprawlita, one of the first Sprawl robots with pneumatic pistons (See S. A. Bailey, J. G. Cham, M. R. Cutkosky, and R. J. Full. Comparing the locomotion dynamics of the cockroach and a shape deposition manufactured biomimetic hexapod. In Experimental Robotics Vii, volume 271, pages 239-248, 2001). These patterns are similar except that the rear legs of the robot produce a negative horizontal force (drag) at the end of each stride rather than at the beginning as with the insect. The pattern for iSprawl is again similar, with a couple of noticeable differences: the front legs provide less braking force and the rear legs have less drag. The reduction in parastic foot drag is partly responsible for the greater speed of iSprawl.

E. Conclusions

The development of a light and flexible power distribution system has allowed the creation of an autonomous, biomimetic sprawled hexapod. A comparison of the locomotion dynamics of the electrically powered iSprawl and the pneumatically driven Sprawl robots shows that despite the difference in actuation schemes, both robots demonstrate comparably fast and stable running with an open-loop actuation pattern. This suggests that the key design principles embodied in the Sprawl robots, namely sprawled posture, thrusting legs, and passive hip joints with rotational compliance and damping, have practical utility beyond this family of robots. A comparison of the leg extension profiles and ground reaction forces between the electric and pneumatic variants of the Sprawl robots shows that despite small differences, the essential motions and forces for fast and stable locomotion have been preserved. We also found that when the passive properties of the robot, including the center of mass location, leg equilibrium angles, and leg stiffnesses were adjusted empirically for smoother running, the robot was able to run more than twice as fast.

A more detailed tuning of the leg impedance may result in faster and more stable running. In comparison to other legged robots, iSprawl achieves an exceptionally high speed and Froude number, chiefly by virtue of having an extremely high stride frequency for its size. A comparison with running animals is somewhat more complicated. iSprawl's Froude number of 3.5 is one at which most animals would have switched from a trot to a gallop. There are some notable exceptions such as elephants, which “Groucho-run” with Froude numbers as high as 3.4 and cockroaches, which continue to use an alternating tripod gait for Froude numbers as high as 6-7. However, like other animals, cockroaches do not achieve their highest speeds by continuing to increase stride frequencies beyond the normal rate used for running. Rather they increase their effective stride length via aerial phases. In contrast, iSprawl runs with a stride frequency comparable to that of a mouse although it has a body weight comparable to that of a well-fed rat. In comparison to other robots and to animals, iSprawl is capable of high stride frequencies chiefly because of the very low rotational inertia of its legs. This, in turn, is a direct consequence of having a single actuation source mounted in the body, with reciprocating motion directed to the feet via push-pull cables. Indeed, given the passive 45 Hz swing frequency of the legs, the maximum running frequency could be even higher if a different motor and battery source were used.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example the invention could be used for legged robots with two or more legs as well as of different body dimensions/sizes. In the specific embodiment a motor is used with a double crank-slider mechanism. A person skilled in the art readily appreciates that various electrical power systems can be used and adapted to generated push-pull motions. All such variations are considered to be within the scope and spirit of the present invention as defined by the following claims and their legal equivalents.

What is claimed is:

1. A power transmission system for a legged robot, comprising:
(a) a rotational motor or engine adapted to generate push-pull motions; and
(b) a plurality of flexible push-pull cables mechanically coupled to said motor or engine, wherein each one of said flexible cables is housed in a low-friction flexible tube, wherein each one of said flexible tubes has a rigid shell at both ends of said flexible tube, and wherein each one of said flexible push-pull cables represents a leg of said legged robot,
wherein said flexible push-pull cables are divided into at least two sets of legs and wherein said power transmission system distributes the power between said legs and across said sets of legs.

2. The legged robot as set forth in claim 1, further comprising an axial compliant element on each one of said flexible tubes, wherein said axial compliant element is used for dynamically tuning said power transmission system to obtain smooth running.

3. The legged robot as set forth in claim 1, wherein the proximal end of each one of said flexible push-pull cables further comprises a rigid shaft mechanically coupled to said flexible push-pull cable, wherein said rigid shaft is capable of extending passed the proximal end of said flexible tube.

4. The legged robot as set forth in claim 1, wherein each one of said legs further comprises a passive joint flexure connecting each one of said legs to the body of said legged robot, wherein said joint flexure provides rotational compliance and damping.

5. The legged robot as set forth in claim 1, wherein each one of said legs further comprises a joint control servo to change the equilibrium of said leg.

6. The legged robot as set forth in claim 1, wherein said push-pull cables operate at a frequency of at least 10-15 Hz leading to a legged locomotion of said legged robot at a Froude number of 3 or greater.

7. A legged robot, comprising: a plurality of legs wherein each one of said legs comprises a flexible push-pull cable, wherein each one of said flexible cables is housed in a low-friction flexible tube, wherein each one of said flexible tubes has a rigid shell at both ends of said flexible tube, wherein each one of said flexible push-pull cables represents a leg of said legged robot, and wherein said flexible push-pull cables are divided into at least two sets of legs.

8. The legged robot as set forth in claim 7, further comprising a rotational motor or engine adapted to generate push-pull motions of said flexible push-pull cables and distributing the power between said legs and across said sets of legs.

9. The legged robot as set forth in claim 7, further comprising an axial compliant element on each one of said flexible tubes, wherein said axial compliant element is used for dynamically tuning said power transmission system to obtain smooth running.

10. The legged robot as set forth in claim 7, wherein each one of said legs further comprises a passive joint flexure connecting each one of said legs to the body of said legged robot, wherein said joint flexure provides rotational compliance and damping.

11. The legged robot as set forth in claim 7, wherein each one of said legs further comprises a joint control servo to change the equilibrium of said leg.

12. The legged robot as set forth in claim 7, wherein said push-pull cables operate at a frequency of at least 10-15 Hz leading to a legged locomotion of said legged robot at a Froude number of 3 or greater.

13. A legged robot having a plurality of legs, comprising: a power transmission system for generating push-pull motions of said flexible push-pull cables, wherein each one of said flexible push-pull cables represents one of said plurality of legs in said legged robot, and wherein said flexible push-pull cables operate at a frequency of at least 10-15 Hz, leading to a legged locomotion of said legged robot at a Froude number of 3 or greater.

14. The legged robot as set forth in claim 13, wherein each one of said flexible cables is housed in a low-friction flexible tube, wherein each one of said flexible tubes has a rigid shell at both ends of said flexible tube, wherein each one of said flexible push-pull cables represents a leg of said legged robot, and wherein said flexible push-pull cables are divided into at least two sets of legs.

15. The legged robot as set forth in claim 13, further comprising an axial compliant element on each one of said flexible tubes, wherein said axial compliant element is used for dynamically tuning said power transmission system to obtain smooth running.

16. The legged robot as set forth in claim 13, wherein each one of said legs further comprises a passive joint flexure connecting each one of said legs to the body of said legged robot, wherein said joint flexure provides rotational compliance and damping.

17. The legged robot as set forth in claim 13, wherein each one of said legs further comprises a joint control servo to change the equilibrium of said leg.
